(19) United States
(12) Patent Application Publication
(10) Pub. No.: US 2018/0165704 A1
(43) Pub. Date: Jun. 14, 2018

(54) SYSTEM, METHODS, AND DEVICES FOR REAL-TIME REWARDS ACCUMULATION AND REDEMPTION

(71) Applicant: Dynamics Inc., Cheswick, PA (US)

(72) Inventors: Jeffery D. Mullen, Glenshaw, PA (US); Doug Sutherland, Brampton (CA); Jonathan L. Beaver, Cranberry, PA (US)

(21) Appl. No.: 15/709,842

(22) Filed: Sep. 20, 2017

Related U.S. Application Data
(60) Provisional application No. 62/384,705, filed on Sep. 7, 2016.

(51) Int. Cl. G06Q 30/02; G06Q 20/38

(52) U.S. Cl. CPC G06Q 30/0233; G06F 17/30365; G06Q 20/387

(57) ABSTRACT

A system comprising a rewards database operable to maintain records on a user's accumulated rewards points; and a rewards server operable to receive transaction information from a payment network, calculate an rewards point count associated with the transaction, and reduce the user's accumulated rewards points by the rewards point count; and communicate a credit associated with the transaction information to the payment network.

### BACKGROUND OF THE INVENTION

This patent relates to systems and methods for designing, operating and fulfilling real-time payments with earned rewards at the time of purchase.

### SUMMARY OF THE INVENTION

According to example embodiments, a system may include a rewards database operable to maintain records on a user's accumulated rewards points, and a rewards server operable to receive transaction information from a payment network, calculate an rewards point count associated with the transaction, and reduce the user's accumulated rewards points by the rewards point count, and communicate a credit associated with the transaction information to the payment network.

According to example embodiments, a payment device may include a first button operable to complete a transaction using reward points, and a second button operable to complete a transaction using available funds.

According to example embodiments, a system may include a rewards database operable to maintain records on a user's accumulated rewards points, and a rewards server operable to communicate bonus information to a user, receive transaction information from a payment network, calculate an rewards point count associated with the transaction based on the bonus information, and reduce the user's accumulated rewards points by the rewards point count, and communicate a credit associated with the transaction information to the payment network.

According to example embodiments, a system may include a rewards database operable to maintain records on a user's accumulated rewards points; and a rewards server operable to communicate contest information to a user, receive transaction information from a payment network, calculate an rewards point count associated with the transaction based on the bonus information, and enter the user in the contest based on the contest information.

According to example embodiments, an apparatus may include a rewards server operable to receive transaction information from a payment network, determine rewards points based on the transaction information, and notify a user regarding the receipt of the transaction information.

According to example embodiments, an apparatus may include a dashboard operable to display all pending transaction, rewards points needed to cover each of the pending transactions, and the total rewards points accumulated by a user. The apparatus may further include a second dashboard operable to display a history of all completed exchanges and earnings.

### BRIEF DESCRIPTION OF THE DRAWINGS

FIG. 1 is an illustration of cards and architectures in accordance with the principles of the present invention;

FIG. 2 is an illustration of devices in accordance with the principles of the present invention;

FIG. 3 is an illustration of network topologies in accordance with the principles of the present invention;

FIG. 4 is an illustration of a rewards system in accordance with the principles of the present invention;

FIG. 5 is an illustration of a gamification system in accordance with the principles of the present invention;

FIG. 6 is an illustration of a gamification system in accordance with the principles of the present invention;

FIG. 7 is an illustration of a gamification system in accordance with the principles of the present invention;

FIG. 8 is an illustration of a gamification system in accordance with the principles of the present invention;

FIG. 9 is an illustration of a gamification system in accordance with the principles of the present invention;

FIG. 10 is an illustration of network topologies in accordance with the principles of the present invention; and

FIG. 11 is a process flow in accordance with the principles of the present invention.

### DETAILED DESCRIPTION OF THE INVENTION

Currently, payment rewards systems are configured to allow consumers to earn rewards based on purchases made. Unfortunately, points are typically not available for review until the end of the month (typically as part of the monthly statement). In additional, current systems either periodically send rewards check (for example, once a month, once a quarter, or once a year) or allow users to use points to shop at a “points store,” i.e., an online store designed by the financial institution that provides a small set of products in exchange for certain numbers of points. These rewards systems are slow (only allocating points at the end of the month) and unwieldly (must log onto a specific website and request a rewards check or points transaction). This runs counter to today's culture of instant gratification. This has led to users forgetting or actively avoiding using accumulated rewards. Financial institutions that implement these rewards end up having to carry vast number of these points as liabilities on their books.

Initially, these rewards programs may lead users to inquire about or even sign up for a rewards card. But the delay in receiving rewards points, the bulky means of accessing wards points, and the limited options for exchange reduces the ability of these companies to retain customers.

In addition, rewards programs can require significant amount of overhead. Between rewards offered and the overhead required to manage the rewards program, a rewards program can cost a financial entity between 1% and 2% of consumers' transaction value. For example, a program that give a consumer 1% cash back for purchases, may actually cost the financial entity 2% of the purchase to administer.

What is needed is a way to allow users to accumulate and redeem rewards in real-time using technology that is at their fingertips without requiring any change in processing the transaction on the merchant's end. For example, financial institutions can link a pre-paid, debit, or credit card to a rewards account that allows a user to make purchases and immediately track their rewards. Notifications can be sent that rewards have been earned. Users can access their account directly through links on these notification or through applications on mobile or non-mobile devices, and use points in relation to any purchase they make. By continually offering consumers ways to use their points, not only is consumer engagement and loyalty increased, but a financial entity's financial books become easier to maintain. In addition, what is needed is a way to lower the costs of these reward programs while still driving consumers to adopt a card and continually use the card.

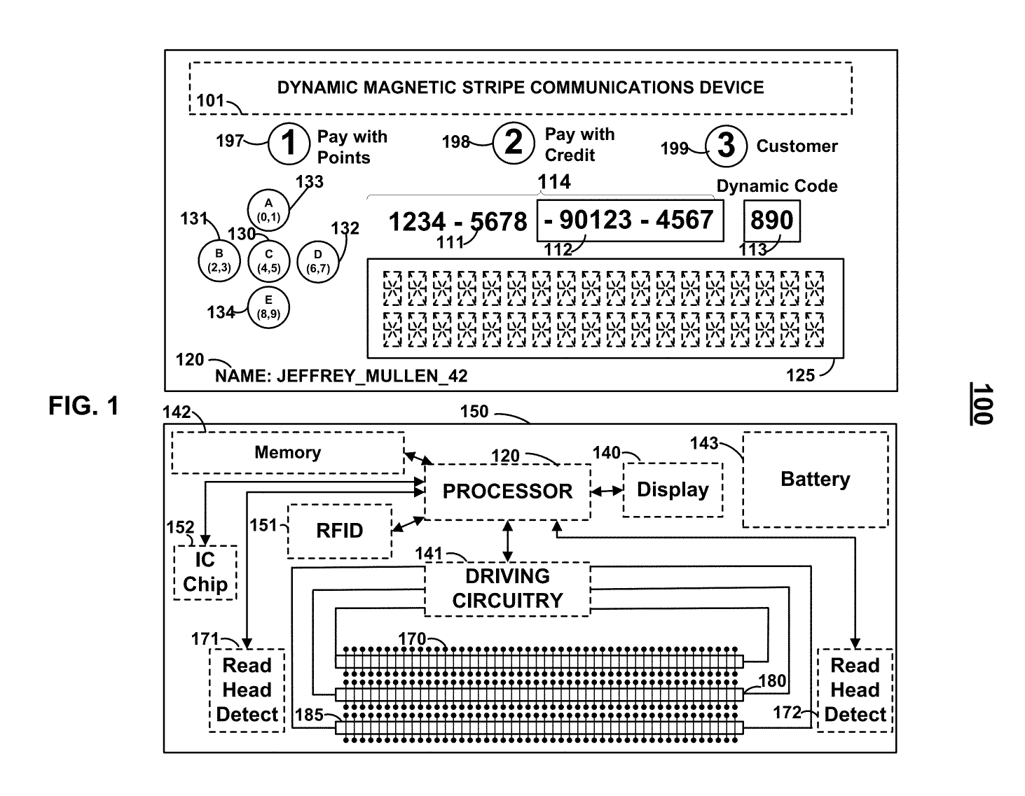

FIG. 1 shows cards and architectures according to example embodiments. Referring to FIG. 1, card 100 may include, for example, dynamic magnetic stripe communications device 101, one or more displays (e.g., displays 112, 113 and 125), permanent information 120, one or more buttons (e.g., buttons 130-134 and 197-199) and/or dynamic number 114. Dynamic number 114 may include permanent portion 111. Permanent portion 111 may be, for example, printed, embossed and/or laser etched on card 100.

Multiple displays may be provided on card 100 for various purposes. For example, display 112 may utilized to entirely, and/or partially display a dynamic number. Display 113 may be utilized to display a dynamic code (e.g., a dynamic security code). Display 125 may display logos, barcodes, and/or multiple lines of information. A display (e.g., at least one of displays 112, 113 and 125) may be a bi-stable display or non bi-stable display. A bi-stable display may be a display that maintains an image without power.

Permanent information 120 may include, for example, information specific to a user (e.g., a user's name and/or username) and/or information specific to a card (e.g., a card issue date and/or a card expiration date).

Buttons 131-134 and 197-199 may be mechanical buttons, capacitive buttons, or a combination of mechanical and capacitive buttons. Buttons 131-134 may be used, for example, to enter information (e.g., an access code) and/or to make a selection. For example, using buttons 131-134, a user may select options displayed on display 125 that instruct card 100 to communicate (e.g., via a dynamic magnetic stripe communications device, RFID and/or exposed IC chip) a user's instructions to use one of a debit account, a credit account, a pre-paid account, or a point account for a transaction (e.g., a payment transaction). According to at least one example embodiment, more than one account may be selected, for example, where a transaction may be divided between accounts. For example, card 100 may be utilized to indicate a user's desire to use a point account until the point account is exhausted and then a credit account.

Button 197 may be used, for example, to communicate information through dynamic magnetic stripe communications device 101 indicative of a user's desire to conduct a transaction by exchanging rewards points to make a purchase. Button 198 may be used, for example, to communicate information through dynamic magnetic stripe communications device 101 indicative of a user's desire to conduct a transaction in a traditional way, for example paying with credit, debit, or using a pre-paid account. Persons skilled in the art will appreciate that pressing a button (e.g., button 197) may cause information to be communicated through device 101 when an associated read-head detector detects the presence of a read-head of a magnetic stripe reader. Button 198 and 199 may be utilized to communicate (e.g., after button 198 and/or 199 are pressed and after a read-head detects a read-head of a reader) information indicative of a user selection.

A user may associate applications to buttons and/or features to applications, for example, on a graphical user interface (GUI). The graphical user interface may be, for example, an application manager provided by one or more entities. The associations may be changed, for example, at any time, periodically, and/or upon the occurrence of an event. According to some example embodiments, a user may associate applications to buttons and/or features to applications by telephone, by electronic mail and/or any other communication method.

Associations between buttons and service provider applications may be maintained by an ecosystem provider, for example, within an ecosystem of applications, transactional methods and types of transactions. When a transactional method (e.g., card 100) is used by a user, the ecosystem provider may receive transactional data and information indicative of a button selected by the user. The ecosystem provider may determine the identity of an application associated to the button, and may communicate some or all of the information and/or transactional data to the application and/or the service provider. The service provider and/or the application may provide a feature associated with the application based on the information and/or transactional data.

Reward points may be earned or used based on the use of different transactional methods. For example, when the payment transaction is performed, a users rewards account may accumulate additional points, based on the transaction value and other factors, or may be reduced by points to cover part or all of the transactions. A reward may be provided for the use of a particular payment method during a payment transaction. A user may purchase an item using the particular payment method (e.g., may select a particular credit account using buttons 130-134 and display 125). When the purchase is performed, the reward may be communicated to the user. As yet another example, suppose a service provider provides a reward feature. A reward may be provided for processing a transaction using a particular transaction processor (e.g., issuer, acquirer and/or payment network).

Button 199 may be utilized to communicate information indicative of, for example, a customer feature. Customer features may be, for example, general features, enhancements to existing features and/or exclusive features. A customer may be, for example, an ecosystem user requesting a transaction (e.g., a purchase, a loan from a library and/or the like) with a merchant (e.g., for-profit and/or not-for-profit) that uses the ecosystem to process transactions. The customer features may be available, as one non-limiting example, when both the user and the merchant make use of the same ecosystem for a transaction.

For example, if the transaction is a purchase, the ecosystem provider may be a merchant acquirer (e.g., a credit card processor), the merchant may use the ecosystem provider as a merchant acquirer, and the user may be a user of payment methods compatible with an ecosystem provided by the ecosystem provider. A user may associate a feature enhancing an existing feature within an ecosystem to button 199. The user may, for example, press button 199 and another button (e.g., button 198), and provide card 100 to a merchant. The merchant may swipe card 100 using a card reader. Information indicating that buttons 199 and 198 have been pressed, and that an ecosystem card reader has been used, may be communicated to the ecosystem provider via the card reader. The ecosystem provider may identify an application associated with button 199 and may enhance a feature provided by the application (e.g., provide a double reward related to the button 198). According to at least one example embodiment, a reward associated with button 198, and a reward associated with button 199, may be provided to the user.

Button 199 may be associated to any of a number of different customer related features selectable by a user using, for example, a graphical user interface, a telephone, electronic mail and/or the like. According to example embodiments, although a customer feature is described with respect to button 199, a customer feature may be associated to any button or selection (e.g., any of buttons 197-199, and/or a selection selectable using buttons 130-134 and display 125).

Architecture 150 may be utilized with any card (e.g., any card 100). Architecture 150 may include, for example, processor 120, display 140, driving circuitry 141, memory 142, battery 143, radio frequency identification (RFID) 151, integrated circuit (IC) chip 152, electromagnetic field generators 170, 180, and 185, and read-head detectors 171 and 172.

Processor 120 may be any type of processing device, for example, a central processing unit (CPU) and/or a digital signal processor (DSP). Processor 120 may be, for example, an application specific integrated circuit (ASIC). Processor 120 may include on-board memory for storing information (e.g., drive code). Any number of components may communicate to processor 120 and/or receive communications from processor 120. For example, one or more displays (e.g., display 140) may be coupled to processor 120. Persons skilled in the art will appreciate that components may be placed between particular components and processor 120. For example, a display driver circuit may be coupled between display 140 and processor 120.

Memory 142 may be coupled to processor 120. Memory 142 may store data, for example, data that is unique to a particular card. Memory 142 may store any type of data. For example, memory 142 may store discretionary data codes associated with buttons of card 100. Discretionary data codes may be recognized by remote servers to effect particular actions. For example, a discretionary data code may be stored in memory 142 and may be used to cause a third party service feature to be performed by a remote server (e.g., a remote server coupled to a third party service such as an online voucher and/or coupon provider).

Different third party features may be, for example, associated with different buttons and a particular feature may be selected by pressing an associated button. According to some example embodiments, a user may select a third party feature from a list displayed to the user. For example, the user may scroll through a list of features on a display (e.g., a display on the front of the card). A user may scroll through a list using buttons on card 100. The list of features may be displayed to the user individually (e.g., one or more buttons may be used to change which feature is displayed), in groups and/or all features may be simultaneously displayed.

According to at least one example embodiment, a user may select a type of payment on card 100 via manual input interfaces. The manual input interfaces may correspond to displayed options (e.g., displayed on display 125) and/or may be independent buttons. Selected information may be communicated to a magnetic stripe reader via a dynamic magnetic stripe communications device. Selected information may also be communicated to a device (e.g., a mobile telephonic device) including a capacitive sensor and/or other type of touch sensitive sensor.

Architecture 150 may include any number of reader communication devices. For example, architecture 150 may include at least one of IC chip 150, RFID 151 and a magnetic stripe communications device. IC chip 150 may be used to communicate information to an IC chip reader (not illustrated). IC chip 150 may be, for example, an EMV chip. RFID 150 may be used to communicate information to an RFID reader. RFID 150 may be, for example, a RFID tag. A magnetic stripe communications device may be included to communicate information to a magnetic stripe reader. For example, a magnetic stripe communications device may provide electromagnetic signals to a magnetic stripe reader.

Different electromagnetic signals may be communicated to a magnetic stripe reader to provide different tracks of data. For example, architecture 150 may include electromagnetic field generators 170, 180, and 185 to communicate separate tracks of information to a magnetic stripe reader. Electromagnetic field generators 170, 180, and 185 may include a coil (e.g., each may include a coil) wrapped around one or more materials (e.g., a soft-magnetic material and a non-magnetic material). Each electromagnetic field generator may communicate information, for example, serially and/or in parallel to a receiver of a magnetic stripe reader for particular magnetic stripe track.

Architecture 150 may include read head detectors 171 and 172. Read-head detectors 171 and 172 may be configured to sense the presence of a magnetic stripe reader (e.g., a read-head housing of a magnetic stripe reader). Information sensed by the read-head detectors 171 and 172 may be communicated to processor 120 to cause processor 120 to communicate information serially from electromagnetic generators 170, 180, and 185 to magnetic stripe track receivers in a read-head housing of a magnetic stripe reader.

According to at least one example embodiment, a magnetic stripe communications device may change the information communicated to a magnetic stripe reader at any time. Processor 120 may, for example, communicate user-specific and card-specific information through RFID 151, IC chip 150, and/or electromagnetic generators 170, 180, and 185 to card readers coupled to remote information processing servers (e.g., purchase authorization servers). Driving circuitry 141 may be utilized by processor 120, for example, to control electromagnetic generators 170, 180, and 185.

Architecture 150 may include, for example, a light sensor (not illustrated). Architecture 150 may receive information from a light sensor. Processor 120 may determine information received by a light sensor.

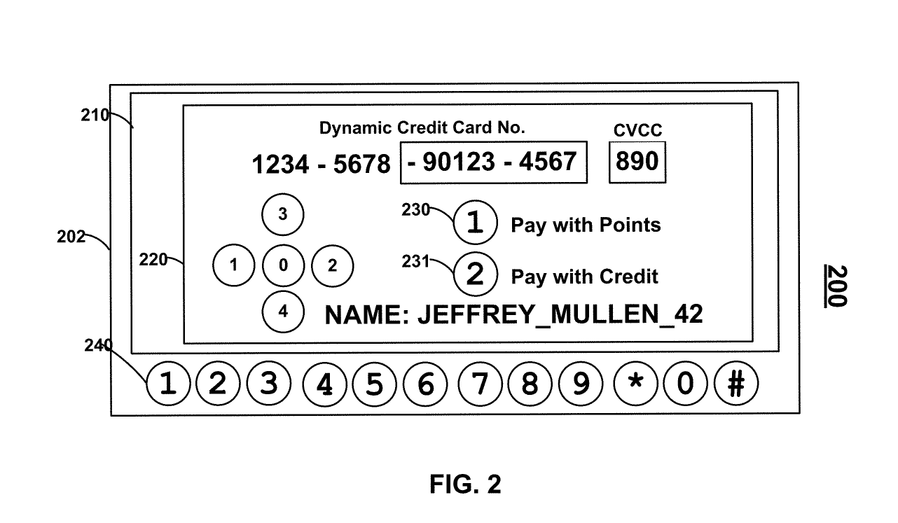

FIG. 2 shows device 200. Device 200 may be, for example, a mobile telephonic device and/or other device (e.g., portable computer such as a portable tablet computer). Device 200 may include, for example, housing 202, display 210, device card 220, physical buttons 240, and virtual buttons 230 and 231.

Display 210 may include, for example, light-sensitive and/or touch-sensitive elements. Device 200 may communicate information to a card reader, for example, via a contactless signal (e.g., an RFID signal) and/or a contact-based signal (e.g., a USB connection).

Device 200 may include a device card 220 and/or virtual buttons 230 and 231. Device card 220 may be a virtual representation of a card and/or any information identifying a payment method (e.g., credit account number). Persons skilled in the art will appreciate that any physical card described herein may be provided as a device card on, for example, a computing system (e.g., a mobile telephonic device and/or a computer). Physical buttons of a physical card may, for example, correspond to virtual buttons of a device card.

Virtual button 230 may, for example, correspond to completing a transaction by paying with points while virtual button 231 may, for example, correspond to completing a transaction in a traditional manner (e.g., using credit, debit, or a pre-paid account). According to at least one example embodiment, every feature may not be provided by a third party service provider. Persons skilled in the art will appreciate that the device provider may, for example, provide features.

All features for a card may be utilized, for example, with a particular payment account (e.g., a credit account) such that a payment transaction with that payment account is performed if any feature is selected. As another example, one or more features may be associated with a payment account (e.g., a credit account) while an additional one or more features may be associated with a different payment account (e.g., a debit account). Accordingly, a selected feature associated with a credit account may be utilized to make a purchase with credit and may perform an additional action associated with that feature. A different selected feature associated with a debit account may be utilized to make a purchase with debit and may perform an additional action associated with that different feature.

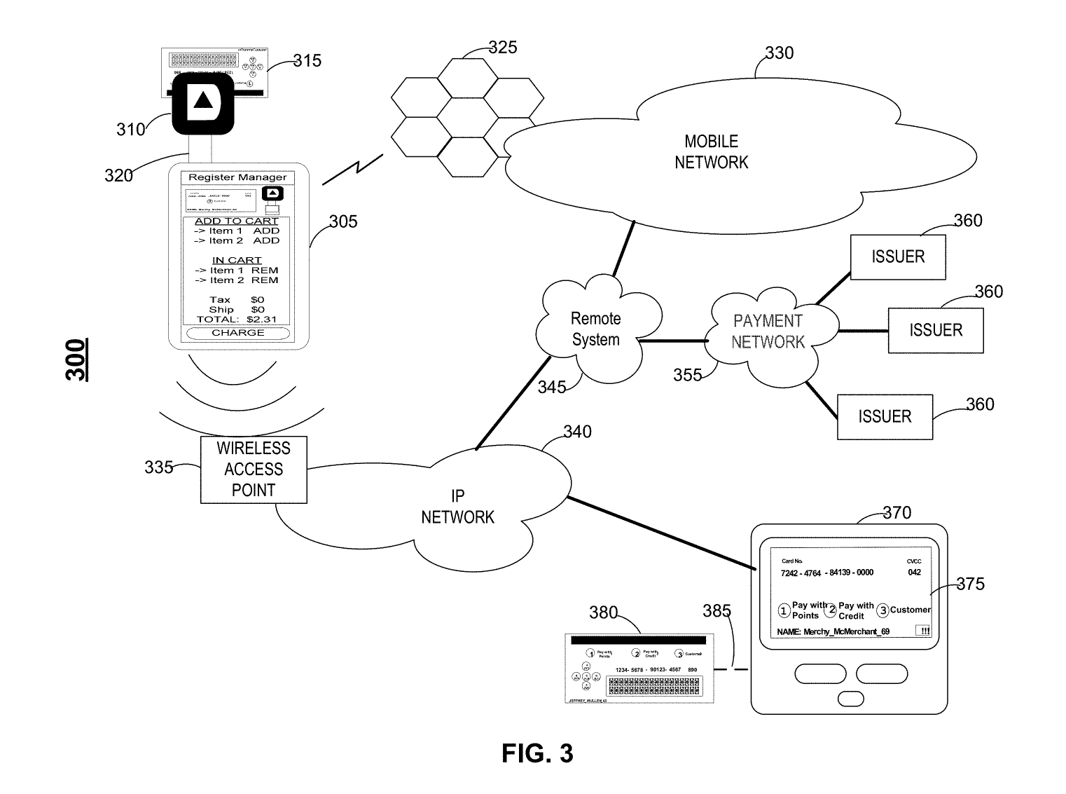

FIG. 3 shows network topologies according to example embodiments. Referring to FIG. 3, network topology 300 may be a logical topology of a transactional network including multiple network elements. The network elements may include, for example, mobile device 305, card reader 310, card 315, network access infrastructure 325, wireless access point 335, mobile network 330, IP network 340, payment network 355, device 370, contactless device 380, issuers 360, and/or remote system 345.

Mobile device 305 may be, for example, a mobile telephonic device, a personal digital assistant (PDA), an electronic tablet, a laptop, a global positioning system (GPS), an MP3 player, a smartphone and/or the like. Mobile device 305 may be used by any transactional entity, for example, a user, a merchant, a biller, an enterprise, a government, a non-profit organization and/or the like. Card reader 310 may be, for example, a data input device configured to read data from a storage medium (e.g., card 315). For example, card reader 310 may receive data from a magnetic stripe, EMV chip, contactless (e.g., RFID) technology and/or the like. Card reader 310 may connect to mobile device 305 via, for example, interface 320. Interface 320 may be an input to, for example, any one of multiple ports of a mobile device 305, for example, an input to a universal serial bus (USB) port, MicroUSB port, 32-pin connector, a headphone jack, an Ethernet port and/or the like.

Remote system 345 may be an entity providing one or more ecosystems of applications and transactional methods, and may be, for example, a transaction processor (e.g., an issuer, a merchant acquirer, an acquirer processor, a payment network and/or the like). Issuers 360 may be issuer processors and/or issuers of transactional methods compatible with one or more ecosystems (e.g., issuing financial institutions). Payment network 355 may be, for example, an entity routing transactional information between, for example, ecosystem provider 345 and issuers 360.

Remote system 345, application manager provider 350, issuers 360, and/or payment network 355 may be connected by, for example, IP network 312, mobile network 312, private networks, trusted networks, encryption networks, sub-networks and/or the like. Connections between network elements may be wired and/or wireless.

Mobile device 305 may include one or more transceivers, receivers and/or transmitters that may communicate with one or more wired networks (e.g., IP network 340 and/or payment network 355) and/or one or more wireless networks (e.g., mobile network 330). Mobile device 305 may, for example, communicate with a cellular station over a wireless radio interface (e.g., a global system for mobile communications (GSM) air interface and/or the like) that may be used by mobile device 305 to communicate information (e.g., voice and data) to cellular network access infrastructure 325 (e.g., one or more GSM base transceiver stations, base station controllers and mobile switching centers). Persons skilled in the art will appreciate that cellular network access infrastructure 325 may utilize any multiple access architecture, for example, a code-division multiple access architecture and/or a time-division multiple access architecture.

Mobile device 305 may, for example, communicate with wireless access point 335 over a wireless interface (e.g., a Bluetooth interface, Wi-Fi interface and/or the like). Mobile device 305 may, for example, access one or more wired networks (e.g., IP network 312 and/or payment network 314) and/or one or more wireless networks (e.g., mobile network 310) without the need to first gain access to cellular network access infrastructure 325.

Mobile device 305 may initiate a financial transaction with one or more network entities and/or devices. Transactional information (e.g., a payment account number and/or a card expiration date of a purchaser) may be used to process the financial transaction. The transactional information may be communicated to mobile device 305 from, for example, card 315 via card reader 310.

For example, a financial transaction may include a purchase of items for sale by a user. A purchaser's request to purchase the items may be initiated by a browser of mobile device 305 via an access point, for example, wireless access point 335 and/or cellular network access infrastructure 325. Mobile device 305 may obtain payment information via card reader 310 (e.g., when card 315 is swiped through card reader 310), and may communicate the payment information to one or more network elements for transactional processing. For example, payment information may be communicated to ecosystem provider 345 (e.g., a merchant acquirer).

Transactional processing may include multiple transactional events and associated transactional communication flows. Examples of transactional events may include authorizations, settlements, statement debits (e.g., piggyback events), statement credits, returns, partial returns, voids, adjustments and/or chargebacks. Examples of transactional communication flows may include authorization, batching, clearing and funding.

Authorization of a purchase may include mobile device 305 communicating transactional information to remote system 345. Based on the transactional information, remote system 345 may communicate a portion of the transactional information, all of the transactional information and/or information related to the user (e.g., a user-merchant) to one or more of rewards systems for provision of one or more rewards actions. In response to receiving transactional information and/or user information from remote system 345, the one or more rewards systems may, for example, communicate a request for a statement credit and/or statement debit (e.g., a piggyback charge) to remote system 345. For example, a reward provided by an rewards system may include providing a rebate (e.g., statement credit) to a purchaser buying an item via the user and/or a monetary value to the user (e.g., statement credit) for selling a particular item using remote system 345. Remote system 345 may authorize the purchase, the statement credit and/or the statement debit, and/or request authorization from one or more of issuers 360. Remote system 345 may, for example, communicate authorization of the purchase to mobile device 305 and/or decline to authorize the purchase.

Upon authorization of a purchase, payment transaction information may be recorded onto a receipt that may be delivered to mobile device 305 via any one or more delivery options (e.g., via a short messaging service of mobile network 330 and/or an email delivery service of IP network 340). A payment receipt may, for example, be provided to mobile device 305 as a proof-of-purchase object (e.g., a barcode) that may be provided to a display of mobile device 305 and read by other computing equipment (e.g., a barcode scanner) for proof-of-purchase confirmation.

Authorized transactions may be batched (e.g., aggregated) by mobile device 305 and/or by remote system 345. The batched transaction may be cleared by communicating (e.g., daily) the batched transactions to one or more of issuers 360 (routed by, for example, payment network 314), debiting the purchaser's account and communicating a monetary value from one or more of issuers 360 to remote system 345. Funding may include remote system 345 notifying mobile device 305 that funding has occurred and/or communicating the monetary value to mobile device 305 (and/or a financial institution associated with mobile device 305 in a case where remote server 345 is not the merchant's bank). Various fees may be deducted from the monetary value and paid to various entities during transactional processing.

Persons skilled in the art in possession of example embodiments will appreciate that many transactional models with different communication flows may be applied to example embodiments (e.g., closed or open loop) and transactions may be routed in various ways. For example, although example embodiments described with respect to mobile device 305 may include transactional processing of transactional data by remote server 345 as a merchant acquirer, according to other example embodiments, remote server 345 may perform some or all of the functions of other network elements in addition to those described above with respect to mobile device 305. According to at least one example embodiment, remote server 345 may provide end-to-end “one stop” transactional processing and may perform the functions of payment network 355 and issuers 360.

Persons skilled in the art in possession of example embodiments will appreciate that features may be provided by remote server 345 in various ways.

Device 370 may be, for example, a server, a laptop computer, a PDA, a desktop computer, a mobile device, a stand-alone piece of electronic equipment, and/or the like. Contactless device 380 may be, for example, a powered card and/or a non-powered card (e.g., a powered payment card and/or a non-powered payment card). Device card 375 may be a virtual representation of contactless device 380 or may be an independent device card. Device 370 may include a contactless interface that may initiate, sustain, and/or terminate communication channel 385 between contactless device 380 and device 370. Contactless device 380 and device 370 may communicate via channel 385 using any number of contactless mediums, which may include for example, visible, audible, capacitive, electromagnetic, magnetic, and/or RF mediums.

Contactless device 380 may communicate transactional information to device 370 to initiate a financial transaction (e.g., a purchase) using, for example, an IC chip, RFID tag and/or a magnetic stripe communications device. Transactional information may be communicated from contactless device 380 to device 370 in support of, for example, processing of the financial transaction. For example, device 370 may communicate transactional information and a purchase amount to remote server 345. Remote server 345 may authorize the transaction and/or may obtain authorization from one or more of issuers 360, and may communicate the authorization to device 370. The user may be provided a receipt upon authorization of the financial transaction.

Device 370 may batch the authorized transaction with other transactions and communicate the batched transactions to remote server 345, and/or remote server 345 may batch the transactions. Remote server 345 may request payment from one or more of issuers 360. The one or more issuers 360 may communicate a monetary value to remote server 345 and debit the user's account. Remote server 345 may communicate the monetary value to device 370 and/or notify device 370 that funding has occurred. Various fees may be deducted from the monetary value and paid to various entities during transactional processing.

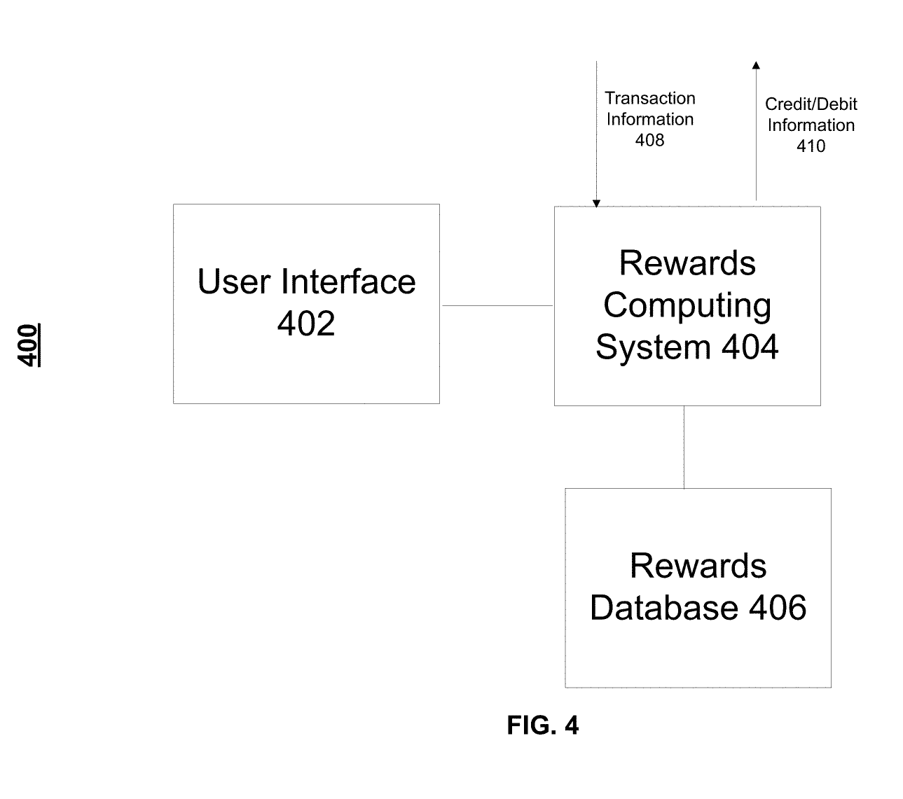

FIG. 4 illustrates a rewards system 400. Rewards system 400 includes an user interface 402, rewards computing system 404, and rewards database 406.

In an embodiment, a user may create an account with rewards system 400. A user may provide identification information, e.g., user name and password, along with account information for the financial account the user wants to link to this rewards system. In an embodiment, the financial account may be a bank card, e.g., a pre-paid card number, debit card number, or credit card number. In another embodiment, the rewards system may be configured to access other types of accounts, for example Paypal® account, bit coin, credit union account information, or online trading account information. A person skilled in the art would understand that these are merely example accounts, and the system may be configured to link to any financial account. In an embodiment, rewards system 400 is hosted by the financial institution that issued the financial account, e.g., a bank, credit union, or investment service provider. In another embodiment, the rewards system 400 is hosted by a third party. In an embodiment, if the user is providing account information for a payment device that is not provided by the hosting entity, the hosting entity may validate account information and ask for further identification information, for example user name and password or account number and routing number.

In an embodiment, rewards computing system 404 may be informed that a transaction has cleared on an associated account, for example, via transaction info 408. In an embodiment, rewards computing system 404 will send a notification to user interface 402. In an embodiment, this notification may include information indicating that a transaction has been cleared. The notification may also indicate that the user can choose to either handle this event as a rewards accumulation event or a rewards redemption event. In an embodiment, this notification may include a link to a user interface to allow the user to indicate what action rewards system should take. In an embodiment, this notification will indicate that if use does not specify an event type by a certain date, for example, the last date of a billing cycle, the system will process the transaction as a default event, for example, a rewards accumulation event.

In an embodiment, if the user indicates that this transaction should be treated as a rewards accumulation event, rewards computing system 404 will calculate the number of rewards points associated with this transaction. In an embodiment, rewards system 404 will update rewards database 406 with this information.

In an embodiment, if the user indicates that this transaction should be treated as a rewards redemption event, rewards computing system 404 prompt the user for additional information. For example, rewards computing system 404 may inform the user of the current outstanding points the user has accumulated and the total points needed to exchange in order to cover this transaction, i.e., the number of points that would need to be exchanged to provide a credit matching the value of this transaction to the user's account. In an embodiment, if the user has enough credits to complete the exchange, the user may be prompted if they would like to continue. In an embodiment, if the user does not have enough credits to complete the exchange, rewards computing system 404 may inform the user that the user has not accumulated enough rewards points, and treat this as a rewards accumulation event. In another embodiment, if the user does not have enough credits to complete the exchange or of the user chooses not to complete an exchange, rewards computing system 404 may query the user about completing a partial-rewards redemption event. If the user responds affirmatively, then rewards computing system 404 may prompt the user to indicate how many rewards point they would like to exchange. In an embodiment, rewards computing system may indicate an exchange rate between points and value. In an embodiment, rewards computing system may calculate and display a value when the user enters the number of points. A person skilled in the art would understand that there are many ways this can be performed. Once the user has determined how many points to exchange, rewards computing system 404 will deduct those points from the user's reward account and send information to the financial entity to provide the corresponding credit to the user's financial account.

In an embodiment, a user may log into rewards computing system 404 once their account has been set-up. Rewards computing system 404 may show the user all pending transactions, e.g., all transactions since the end of the last billing cycle, and the number of rewards points needed to cover that transaction. In an embodiment, rewards computing system 404 also shows the total number of rewards points accumulated by the user. The user may select any transaction. In an embodiment, if the user has enough credits to complete the exchange, the user may be prompted if they would like to continue. In an embodiment, if the user does not have enough credits to complete the exchange, rewards computing system 404 may inform the user that the user has not accumulated enough rewards points, and treat this as a rewards accumulation event. In another embodiment, if the user does not have enough credits to complete the exchange or of the user chooses not to complete an exchange, rewards computing system 404 may query the user about completing a partial-rewards redemption event. If the user responds affirmatively, then rewards computing system 404 may prompt the user to indicate how many rewards point they would like to exchange. In an embodiment, rewards computing system may indicate an exchange rate between points and value. In an embodiment, rewards computing system may calculate and display a value when the user enters the number of points. A person skilled in the art would understand that there are many ways this can be performed. Once the user has determined how many points to exchange, rewards computing system 404 will deduct those points from the user's reward account, update rewards database 406, and send information to the financial entity to provide the corresponding credit to the user's financial account.

In an embodiment, a powered card ______ may be used to perform a transaction. In an embodiment, powered card ______ may include a button indicating that the transaction is to be completed using points. In an embodiment, powered card may include a button allowing the user to indicate that the transaction is to be completed in the traditional manner, e.g., using credit, debiting the user's account, or using a prepaid account. Rewards computing system 404 may be informed that a transaction has cleared on an associated account, for example, via transaction info 408. In an embodiment, rewards computing system 404 will also receive a notification from the system indicating the user's preference regarding whether a credit related to this transaction should be provided in exchange for points and process the transaction accordingly. For example, if the user indicated that they would like the transaction to be processed in a traditional manner, rewards system may indicate this to the financial entity. In an embodiment, if the user selects a traditional manner to process the transaction no further information need be sent to the financial entity. Instead, rewards computing system 404 will update the rewards point total stored in rewards database 406 and may notify the user accordingly.

In an embodiment, if the user indicated that they would like to pay with points, rewards system may determine if the user has enough points to cover the transaction. If the user has enough points, rewards computing system may notify the user that the transaction will be processed as a rewards redemption event unless the user indicated otherwise by a certain date, for example, within 24 hours of the transaction. Rewards processing system 404 will deduct enough points to cover the transaction from the users account and store the updated total rewards point on rewards database 406 and indicate to the financial entity that a credit equal to the transaction cost should be applied to the user's account.

If the user indicated that they would like to pay with points but did not have enough points, rewards computing system may notify the user that the transaction will be processed as a partial-rewards redemption event unless the user indicated otherwise by a certain date, for example, within 24 hours of the transaction. Rewards processing system 404 will use some or all of the user's accumulated rewards points to cover part of the transaction and store the updated total rewards point on rewards database 406. Rewards processing system 404 will indicate to the financial entity that a credit equal to the portion of the transaction costs covered by the exchanged points should be applied to the user's account.

In an embodiment, rewards computing system 404 may also provide bonus points based on user actions. These bonuses may be provided to incentivize certain actions or modes of completing transactions. For example, rewards computing system 404 may provide bonus points for signing up for a program or recommending the system to other consumers. Rewards computing system 404 may provide bonus points for completing a set number of transactions in a month, or consecutively for a certain number of days. Rewards computing system 404 may provide bonus points for completing transactions on a certain day of the week, day of the month, or time of the year. Bonus rewards may also be offered based on the type of merchant, name of merchant, or location of the merchant. Bonus rewards may also be based on the payment method, for example, which account was used to make a purchase, the type of payment method (e.g., bonus for using credit), how the payment was provided (e.g., swiping a card, tapping a card, or using an EMV reader). In addition, bonus rewards may be based on how the transaction was performed (e.g., making a purchase in person or making a purchase online). Bonus points may also be used to incentivize actions related to the transaction, for example, filling out a survey after the transaction is complete. A person skilled in the art would understand that any combination of the above bonuses, as well as other incentive structures, may be implemented by the rewards computing system.

In an embodiment, rewards computing system 404 may also be configured to allow consumers to enter contests and sweepstakes. For example, users may be automatically entered and notified based on making specific purchases. In an embodiment, rewards computing system 404 may provide a way for users to exchange points to enter into a contest or sweepstakes. In an embodiment, rewards computing system 404 may verify that a user's entry into a given contest or sweepstake conforms with the local laws, with regard to the consumer's local laws, the contest host's local laws, and the laws of the location where the entry is made (for example if based on a purchase in a store, then the laws governing the stores jurisdiction). A person skilled in the art would understand that this may allow the rewards computing system to attract users to specific cards or financial entities while also reducing the cost of maintain a rewards program. In addition, allowing user to use accumulated point to pay for entry into contests and sweepstakes would allow users to receive value for points that they have accumulated but have not been able to use (unlike other rewards programs such as current air miles rewards programs) and reduce the liabilities that the financial entity must carry on its books.

In an embodiment, rewards computing system 404 allows administrators to step up and administer contests and sweepstakes. In an embodiment, administrators may be associated with a financial entity, the rewards computing system 404, a merchant, a third party, or any combination thereof. In an embodiment, the administrator can set up contests with different prizes, for example, cash, gifts, reward points, etc. In an embodiment, rewards computing system 404 may also be configured to collect legal documents needed to administer the contest, for example electronic affidavits from contestants, skill test answers to qualify to receive a prize, etc.

In an embodiment, rewards computing system 404 may also vary the number of bonus points awarded on a given transaction, for example by using rewards points multiples to incentivize certain transactions. For example, rewards computing system 404 may double the number of rewards points a consumer receives for a set amount of time, such as a week, if the consumer refers a friend. In an embodiment, rewards multiples can apply to specific merchants, e.g., rewards earned while shopping at a specific store, or at any store in a specific mall, will grand an additional 10% of rewards points. Alternatively, the cost in points to cover certain transactions may be modified, for example, rewards computing system 404 may indicate that all points used to cover restaurant transactions will only require 90% of the normal number of rewards points. Multiples can be based on any number of different categories, for example, merchant name, merchant category, merchant location, transaction type (In-person or online), payment method (EMV, swipe, wireless), etc. Bonus multipliers may also be used to incentivize actions related to the transaction, for example, filling out a survey after the transaction is complete. A person skilled in the art would understand that any combination of the above bonus multipliers, as well as other incentive structures, may be implemented by rewards computing system 404.

In an embodiment, a consumer may access rewards computing system 404. For example, a consumer may log into a website or access a mobile application that is associated with rewards computing system 404. In an embodiment, when a consumer first creates an account, rewards computing system 404 may be configured to establish one or more ways of communicating with the consumer. For example, rewards computing system 404 may ask the user to select how information should be shared with the consumer, for example, using e-mail, text message, or push notifications. In an embodiment, the consumer may select multiple methods of communication. The consumer may also be able to revise this selection by accessing rewards computing system 404 any time in the future. Each time a consumer accesses rewards computing system 404, they may be presented with their total accumulated rewards point, i.e., the number of rewards points reflected in rewards database 406 for that user. The consumer may also indicate when notification should be sent, for example, after each transaction, at the end of each day, one a week, once a month, etc. In an embodiment, the consumer may also be able to customize these communications, indicating what information they would like the notification to include, such as, a link to access rewards computing system 404, the total number of accumulated points, pending actions, recent activity, etc. In an embodiment, when a consumer accesses rewards computing system 404, the consumer may also be able to update the consumer information, contact information, account information, set permissions, view descriptions of eligible transactions, view the status of current refunds and point exchanges, etc.

In an embodiment, when a consumer accesses rewards computing system 404, the consumer may also be presented with a dashboard listing all pending transactions that are eligible to be completed using points. In an embodiment, this includes only transactions where the consumer's accumulated points are greater than the number of points needed to cover the transaction. In an embodiment, the dashboard will include all pending transactions. For example, those transactions that can be completely covered may be outlined in green, while those that can only be partially covered may be outlined in yellow.

In an embodiment, when a consumer accesses rewards computing system 404, the consumer may also be able to access a dashboard that would allow the user to shop for new times using their accumulated points. In an embodiment, only those items that a consumer has enough points to purchase would be displayed. In an embodiment, all available items may be displayed. For example, even items that require more points than the consumer has would be displayed. In an embodiment, the consumer may be provided a way to purchase additional points.

In an embodiment, when a consumer accesses rewards computing system 404, the consumer may also be able to access additional other dashboards. For example, rewards computing system 404 may provide access to a dashboard that allows a consumer to manage their account. This dashboard may provide information regarding transaction history for this user. This history may include exchanges as well as history regarding when points were earned. In an embodiment, rewards computing system 404 may include a dashboard to allow the user to view and update account information, such as passwords, preferences, registered payment devices, registered users, etc. In an embodiment, a consumer may be able to use one or more dashboards to reconcile reports against transaction logs to confirm that all points have been accounted for.

In an embodiment, rewards computing system 404 may be provided by a financial institution, a merchant, a party within the financial ecosystem, or a third party. Independent of what party provides rewards computing system 404, it may be configured to receive transaction information from one or more financial institutions. This information may include transaction information, for example, the amount of the transaction, the type of the transaction, the merchant, the time of the transaction, the location of the transactions, etc. In an embodiment, this information may also include an indication of whether a powered card was used to complete the transaction, and, if so, did the consumer indicate whether the transaction should be paid using points.

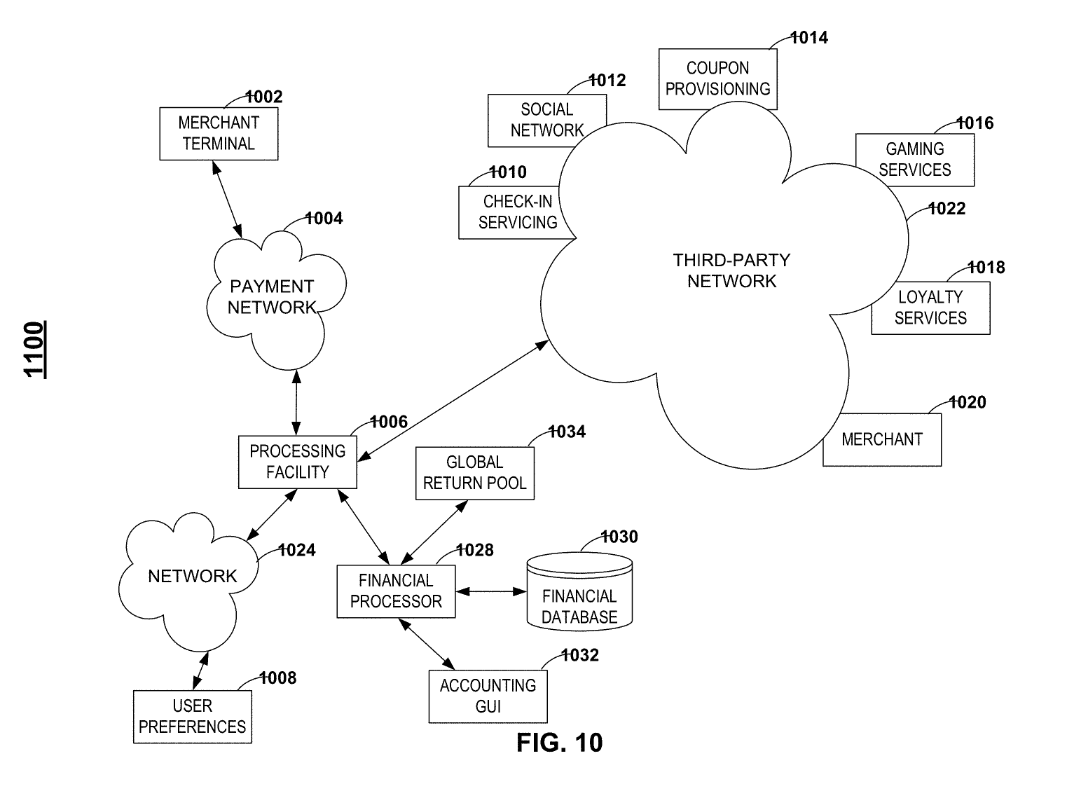

FIG. 10 shows network 1000 that may include third-party network 1022 and various third-party applications 1010-1020. Network 1000 may, for example, include merchant terminal 1002 (e.g., a magnetic stripe reader, an EMV reader, an RFID reader, or an NFC reader) that may accept transactions (e.g., point-of-sale transactions) and may complete such transactions via payment network 1004. Payment network 1004 may, for example, include issuers, merchant acquirers, processors, and/or other network entities that may be required to process and settle transactions initiated by merchant terminal 1002.

Processing facility 1006 may, for example, receive messages from payment network 1004 (e.g., from a processor within payment network 1004) that may be related to at least a portion of transactions conducted within payment network 1004. Customers associated with processing facility 1006 may, for example, elect to distribute at least a portion of data processed within payment network 1004 with the various third-party applications of third-party network 1022.

User preferences 1008 may be selected by each customer to, for example, define what data, if any, may be provided to processing facility 1006 by payment network 1004. A customer may select (e.g., via user preferences 1008) at least a portion of the data provided by payment network 1004 to processing facility 1006 that may be shared with third-party applications 1010-1020.

Network 1024 (e.g., the internet) may be accessed by a user to define user preferences 1008, which may determine how payment network 1004, processing facility 1006, third-party network 1022, and third-party applications 1010-1020 interact for every transaction conducted by each user. A user may, for example, present a non-powered card to merchant terminal 1002 to complete a particular purchase transaction. User preferences 1008 may, for example, be defined by the user to allow details of such a transaction to be communicated by payment network 1004 to processing facility 1006, which may then share at least a portion of such details with one or more third-party applications 1010-1020. A customer may, for example, present a powered card to merchant 1002 to complete a purchase transaction. Prior to presentment, the customer may have selected (e.g., via one or more button presses on the powered card) one or more additional actions to be taken besides the processing of a purchase transaction by payment network 1004 in accordance with user preferences 1008.

A user may, for example, press a button on a powered card that may be associated with communicating a payment message (e.g., a magnetic stripe message) to merchant terminal 1002. Such a button press may, for example, further populate the magnetic stripe message (e.g., populate a discretionary data field within the magnetic stripe message) with a directive to share at least a portion of purchase transaction details conducted at merchant terminal 1002 with a particular third-party application (e.g., merchant 1020). User preferences 1008 may, for example, be selected by the user to determine which actions are to be conducted by the third-party application.

A user may press a button on a powered card that in accordance with user preferences 1008 may, for example, cause a data string to be communicated from payment network 1004 (e.g., from a processor within payment network 1004) to processing facility 1006 that may contain details of a purchase transaction initiated at merchant terminal 1002. Processing facility 1006 may, for example, compare user information (e.g., payment account number and/or payment account holder's name) that may be contained within the data string to a user database to obtain a customer ID (e.g., a customer token) that may be associated with the user information. Sensitive information within the data string (e.g., payment account number and/or payment account holder's name) may be replaced with the customer token and then stored either locally within processing facility 1006 or remotely.

The data string, for example, may further contain information that may be indicative of which button was pressed on the powered card before being presented to merchant terminal 1002. Using the button press information and/or user preferences 1008, processing facility 1006 may populate a third-party message with details that may be communicated to a third-party application (e.g., merchant 1020).

As per an example, a user may elect to share certain transaction information with merchant 1020 each time a certain button is pressed on the user's powered card before presentment to merchant terminal 1002 for payment. Such information may include, for example, merchant information (e.g., merchant's address), date/time information of the purchase, amount of the purchase, type of purchase made, and any other information (e.g., the customer ID associated with the customer's merchant account) that may be selected by the user (e.g., via user preferences 1008). Accordingly, for example, the selected information may be automatically gathered by processing facility 1006, populated within a third-party message and communicated to merchant 1020 via third-party network 1022 (e.g., the Internet).

Upon receipt of the third-party message, merchant 1020 may initiate a second transaction (e.g., a piggyback transaction or statement credit transaction). The second transaction may be communicated to processing facility 1006 via third-party network (e.g., the internet) and processed by processing facility 1006 accordingly. Financial details associated with the second transaction may be processed by financial processor 1028, which may be operating within processing facility 1006 or may be remote to processing facility 1006.

Accounting GUI 1032 and financial processor 1028 may, for example, combine to provide an accounting programming language (APL) interface that may be used to develop a financial management system. Such a financial management system may process financial transactions received by processing facility 1006 (e.g., payment transactions communicated by payment network 1004 and third-party network 1022) and may provide the proper accounting mechanisms that affect the various accounts (e.g., revenue and expense accounts) and account types (e.g., debit and credit account types).

Global return pool 1034 may, for example, be utilized by financial processor 1028 to track the return, or partial return, activity of one or more users and then credit and/or debit the appropriate financial accounts in accordance with such return or partial return activity. In particular, for example, a secondary transaction performed by a third party (e.g., merchant 1020) that may be associated with a primary purchase transaction conducted by a user, may yield revenue (e.g., a percentage of the primary purchase transaction or a fixed fee amount) that is paid to the third party (e.g., merchant 1020) by processing facility 1006. In the event that the primary purchase is voided (e.g., via the user returning merchandise purchased for a full refund), then financial processor 1028 may account for the return, or partial return, by appropriately debiting and/or crediting a user's return pool account balance within global return pool 1034.

A user may, for example, conduct a purchase transaction with a powered or non-powered card that invokes a secondary transaction performed by a third party for value. However, if the user then returns the merchandise purchased, then an amount credited back to the user's payment account may also be added to the user's return pool account within global return pool 434 regardless of which third party performed the secondary transaction. Any future purchases conducted by the user that may invoke one or more secondary transactions performed by third parties may then be subtracted from the user's return pool account balance within global return pool 1034. The third parties performing secondary transactions associated with the future purchases may not receive revenue until the user's return pool account balance is brought back to zero.

As per an example, a user may have a return pool account balance (e.g., $20) and may conduct a purchase transaction (e.g., a $20 purchase transaction) that invokes a secondary transaction that is performed by a third party. However, since the amount of the purchase equals the amount of the user's return pool account balance, the third party receives no revenue, but the $20 purchase transaction is subtracted from the user's return pool account balance to bring the user's return pool account balance to zero.

As per another example, a user may have a return pool account balance (e.g., $20) and may conduct a purchase transaction (e.g., a $40 purchase transaction) that invokes a secondary transaction that is performed by a third party. However, since the user's return pool account balance is non-zero, the $40 purchase transaction is used to bring the user's return pool account balance to zero and the remaining portion (e.g., $20) may be used to generate revenue to the third party (e.g., a percentage of the $20 remainder is paid to the third party).

In an embodiment, rewards computing system 404 may include, in addition to or in place of a reward points accumulation system, a gamification system. A gamification system provides a narrative to engage the consumer, incentivizing the consumer to take actions to achieve specific goals. Further these goals need not be colossal, such as acquiring 400,000 miles to receive a free ticket, but can be small incremental goals related to activity in the game, such as buy a Dove® bar of soap to receive the Dove® chariot. Further, a rewards system may be implemented without requiring changes of rewards computing system 404, of the payment devices, or at any merchant transaction. Integration of gamification can be completely invisible to the consumer.

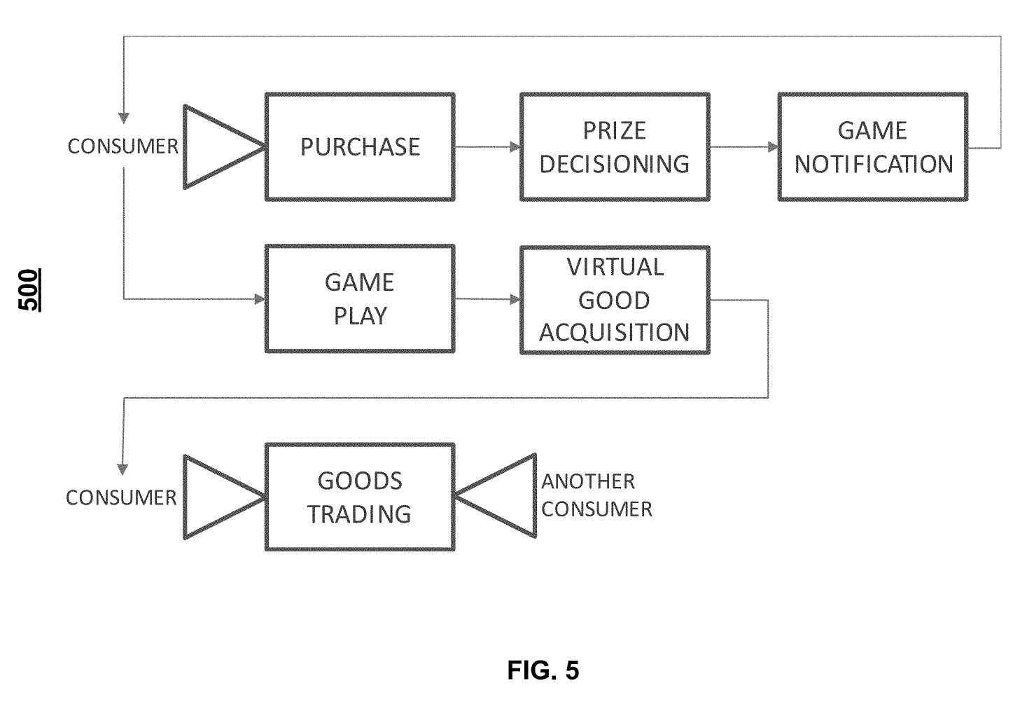

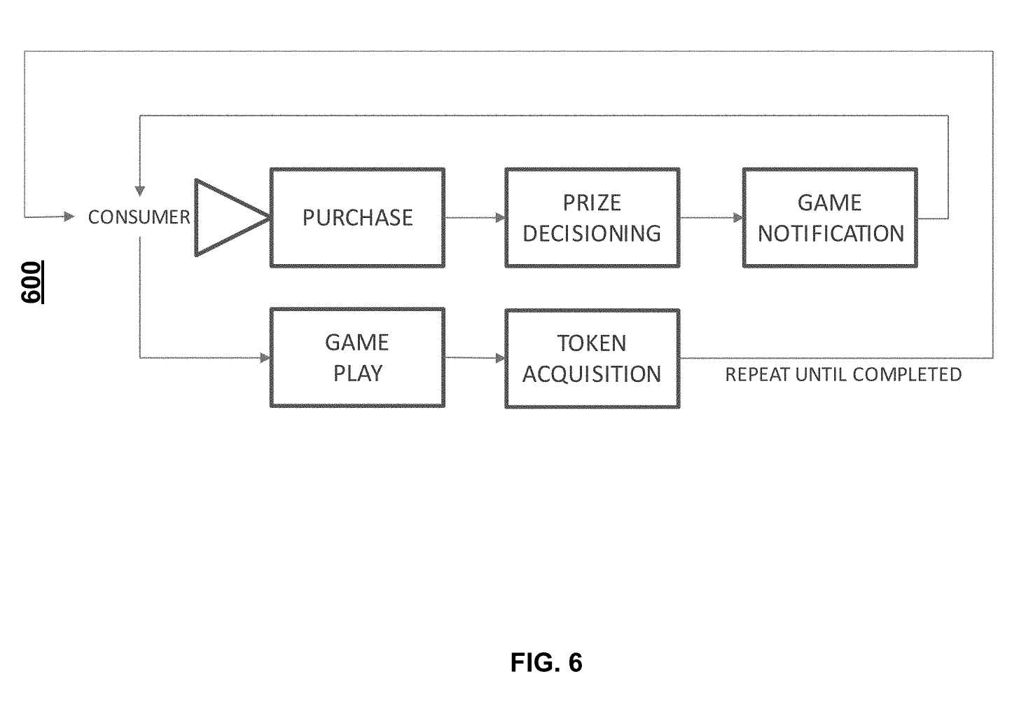

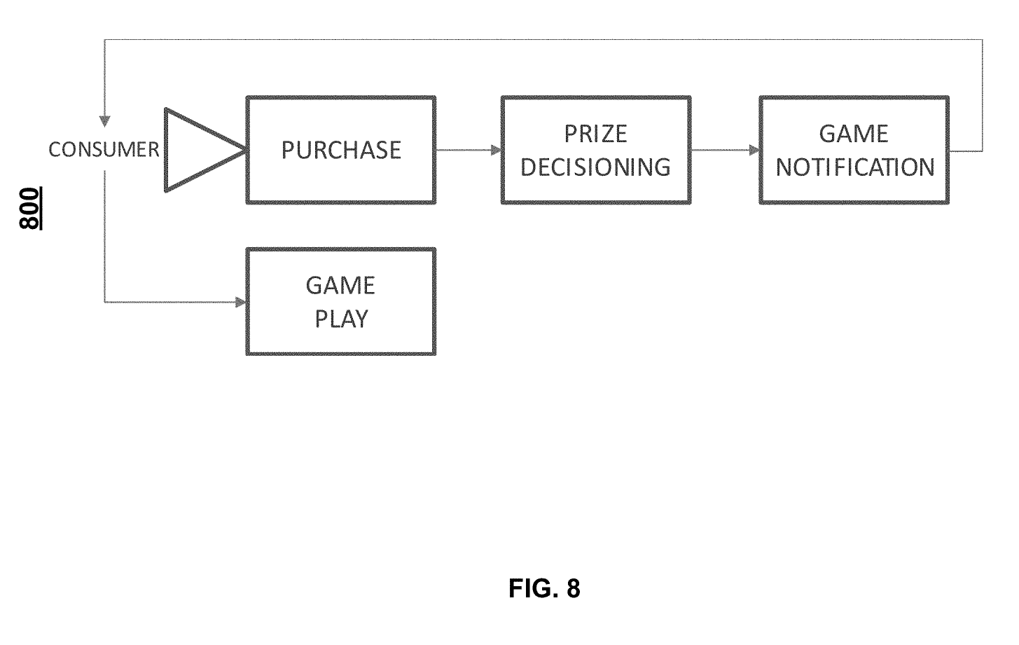

In an embodiment, a consumer may make a purchase related to winning a prize related to a game. In an embodiment, winning the prize is not automatic, but requires a decision (for example a lottery is held for all consumers to make a specific purchase). Once the prize is awarded, rewards computing system 404 notifies the game server. Notification can also be sent to the consumers who were awarded the prize. Game play can be immediately updated to award the prize to those consumers who received it. Consumers can log into the game to receive their reward, for example a virtual collectable. In an embodiment, consumers can also trade virtual collectibles between themselves. This may allow merchants, financial entities, and gaming companies to create new synergies between their perspective users. This is illustrated in FIG. 5. In an embodiment, instead of receiving the virtual collectable directly, consumers may be awarded a token, for example as illustrated in FIG. 6. Tokens may be generic currency that can be used to purchase times in game. Alternatively tokens may be related to specific items, for example virtual collectibles. In an embodiment, once a player collects all the pieces of a virtual collectable, the virtual collectable may be awarded to the user. In an embodiment, once the user collected enough tokens related to a specific virtual collectable, they may be traded in for the virtual collectable. In an embodiment, collecting the pieces for the virtual collectable can be the game itself, as illustrated in FIG. 8. An example of this would be a scratch off game, where the consumer is awarded tiles to scratch of for making certain purchases.

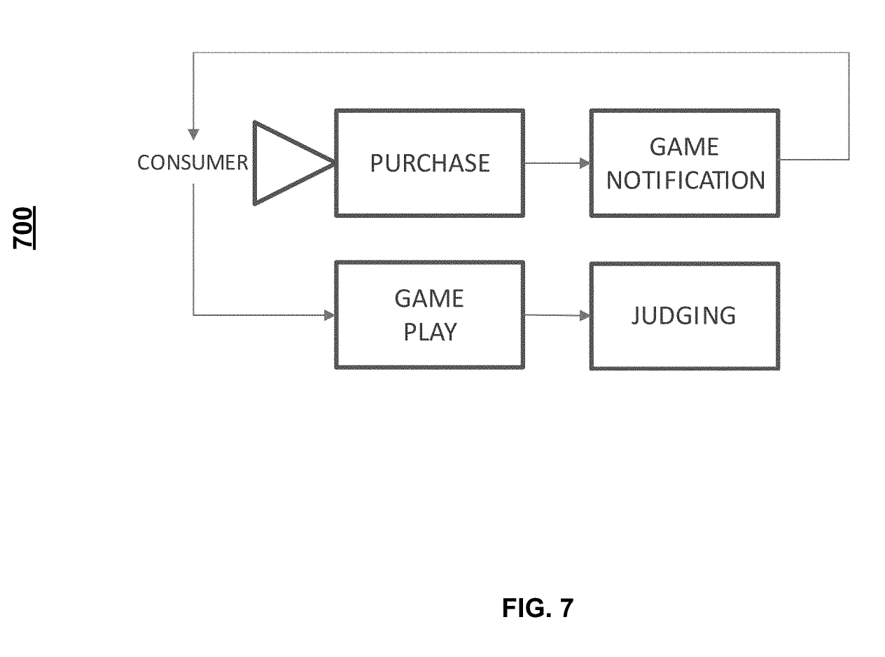

In an embodiment, an administrator can provide access to different types of games. In an embodiment, all consumer may be provided with access to all games. In an embodiment, certain consumers may access certain games. In an embodiment, all consumer that achieve certain goals may access specific games. For example, Consumers with a strong achievement motive are likely to be motivated when the gamification techniques emphasize achievement, success and progress. Consumers with a strong power motive are likely to be motivated when the gamification techniques emphasize status, control and competition. Consumers with a strong affiliation motive are likely to be motivated when the gamification techniques emphasize membership. An administrator may determine different ways and different games to engage each group. For example, a user may receive an entry into a Game of Skill, as illustrated in FIG. 7. The entry may allow them to compete with any number of cardholders in the ecosystem—either at random, within groups, or by invitation. In an embodiment, multiple knock-out levels per game allow thousands of participants translating to material prizes. Example games include games such as Best Quote, Complete the Lyric, Art Challenge, Best Gourmet Meal/Recipe, Pinball Tournament, etc.

Further, an administrator can allow users to access games that provide both real-time rewards and experiential rewards, allowing users to select which system appeals to them the most. This allows the administrator to differentiate this reward system from other that only provide undifferentiated value.

In an embodiment, consumers can be notified, for example by e-mail, SMS message, or in-app message, of a game availability. This notification may be as simple as information the user about the availability of the game, or may include information about the game, such as rules, prizes, odds, etc. Gamification provides clear goals and rules of play, allowing consumers to feel empowered to set goals and work to achieve them.

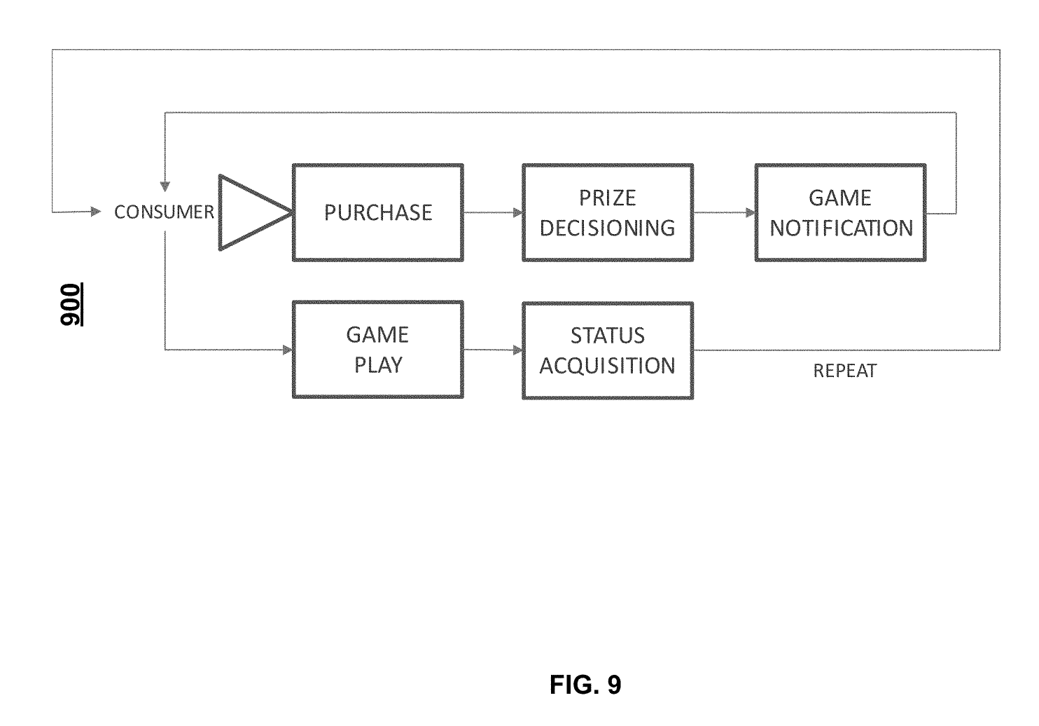

In an embodiment, in addition to collecting rewards, consumers may reach different status or achievement levels as illustrated in FIG. 9. In addition to the prestige that comes from reaching certain levels, other awards can be given to the user upon reaching different levels. Further, prize may be related to other games or events. For example, purchasing certain items, say from a local vendor, may grant consumer super fan status related to a specific player, for example the quarterback of the local team. If, while maintaining the super fan status, the quarterback achieves a goal, for example throwing the game winning touchdown, the consumer will be given a reward, for example a coupon to a game, a concession coupon, or reward points.

An entity, for example a financial entity, may use a gamification system to revitalize a card program, for example one that is starting to show a decline in interest or one that has been well received to further increase market penetration. The gamification system may require a user to exchange a number of reward points to play, make specific purchases (based on item, location, merchant, etc.) to earn the right to play the game. In an embodiment, consumers may continue to earn access to larger prizes based on transaction activity in the rewards computing system 404 or alternatively may earn rewards points from the game. A person skilled in the art would understand that this will increase consumer engagement with the payment methods associated with the game, incentivizing consumer to make more purchases using the payment devices registered with rewards computing system 404 or from partners associated with rewards computing system 404. Thus, gamification may actually drive brand loyalty, both to payment devices, which are used to acquire points and achieve game goals, and to partner brands, that allow consumers to achieve their goals faster by being loyal customers.

Further, gamification will incentivize user to continuously interact with the system, trying to turn small investment into a steady stream of points to gain access to larger, more-appealing reward opportunities. These continual interactions will maintain consumer interest and activity with both the rewards program and the associated cards. In addition, fraud costs will decrease as users will be notified when any and all transactions happen for payment devices associated with the rewards programs. Further, these continuous interactions increase the frequency of feedback loops (i.e., make purchase, get in-game reward, identify further desired rewards, seek new purchased to achieve new reward), avoiding burnout between rewards (a current problem in many rewards programs). In an embodiment, an administrator may also use rewards and messaging to incentivize consumers to take specific actions, for example purchasing certain goods, using specific payment methods, or shopping at certain locations.

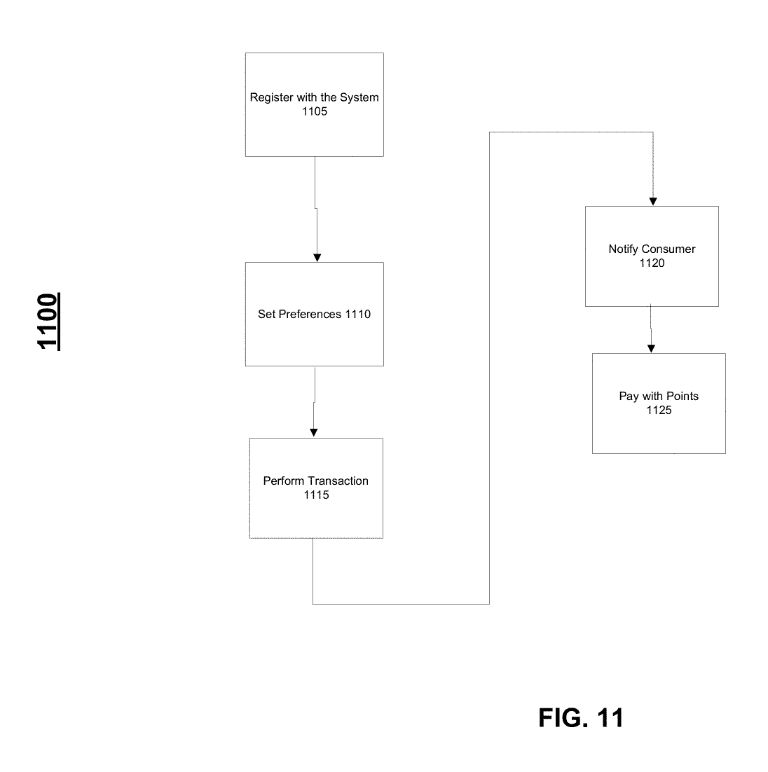

FIG. 11 shows process flow 1100 regarding allowing consumers to accumulate rewards and pay with points.

At step 1105, the consumer registers to use the system. In an embodiment this may include setting up a username and password. This may also include associating one or more payment devices with the account. For payment devices that are not managed by the system, the system may ask for additional information to contact the financial entity that manages the payment device and register the payment device with the system. Additional account information may also be initialized at this point, such as the consumer's name, address, personal information, etc.

At step 1110, a consumer may set preferences with the system. In an embodiment, this may include selecting to receive default notification or customized notifications. In addition, the consumer may select the means that the system will communicate with the consumer, for example using e-mail, text messages, or push notifications.

At step 1115, a consumer may complete a transaction using the payment device. This may be swiping the payment device after an in-store purchase, paying by EMV, or tapping the payment device on the payment terminal. In an embodiment, this may include making a purchase online or over the phone. Once the consumer completes the transaction, it is authorized by a financial entity, which also notifies the rewards system that the transaction has completed, and provides the necessary transaction details.

At step 1120, the rewards system notifies the consumer that a transaction has completed. In an embodiment, it will contact the consumer via one or more of the means selected by the consumer previously. In an embodiment, the notification may include an indication of the number of rewards points required to cover this transaction, the number of rewards points accumulated thus far by the user, or both.

At step 1125, the user may log into the system to determine how this transaction will be handled. In an embodiment, the notification sent will include a link to the reward system such that the user need only click on the link to access the rewards system. In an embodiment, the rewards system will display the pending transactions, the number of points required to cover each pending transaction, and the total number of accumulated point the consumer has. If the consumer has enough points and desires to cover a transaction, the consumer need only click on the associated “Pay with points” button, and the rewards system will notify the financial entity to apply the appropriate credit to the consumer's account.

Persons skilled in the art will also appreciate that the present invention is not limited to only the example embodiments described. Instead, the present invention more generally involves dynamic information. Persons skilled in the art will also appreciate that the apparatus of the present invention may be implemented in other ways than those described herein. All such modifications are within the scope of the present invention, which is limited only by the claims that follow.

I claim:

1. A system comprising:
a rewards database operable to maintain records on a user's accumulated rewards points; and
a rewards server operable to receive transaction information from a payment network, calculate an rewards point count associated with the transaction, and reduce the user's accumulated rewards points by the rewards point count; and communicate a credit associated with the transaction information to the payment network.

2. A payment device comprising:
a first button operable to complete a transaction using reward points; and
a second button operable to complete a transaction using available funds.

3. A system comprising:
a rewards database operable to maintain records on a user's accumulated rewards points; and
a rewards server operable to communicate bonus information to a user; receive transaction information from a payment network, calculate an rewards point count associated with the transaction based on the bonus information, and reduce the user's accumulated rewards points by the rewards point count; and communicate a credit associated with the transaction information to the payment network.

4. A system comprising:
a rewards database operable to maintain records on a user's accumulated rewards points; and
a rewards server operable to communicate contest information to a user; receive transaction information from a payment network, calculate an rewards point count associated with the transaction based on the bonus information, and enter the user in the contest based on the contest information.

5. An apparatus comprising:
a rewards server operable to receive transaction information from a payment network, determine rewards points based on the transaction information, and notify a user regarding the receipt of the transaction information.

6. An apparatus comprising:
a dashboard operable to display all pending transaction, rewards points needed to cover each of the pending transactions, and the total rewards points accumulated by a user.

7. The apparatus of claim 6, further comprising
a second dashboard operable to display a history of all completed exchanges and earnings.
